(19) United States
(12) Patent Application Publication
(10) Pub. No.: US 2003/0213142 A1
(43) Pub. Date: Nov. 20, 2003

(54) Waste stripping tool and method for preparing rolls to press

(76) Inventor: Rob Wenning, Sparks, NV (US)

Correspondence Address: MARSHALL, GERSTEIN & BORUN LLP, 6300 SEARS TOWER, 233 S. WACKER DRIVE, CHICAGO, IL, 60606, US

(21) Appl. No.: 10/404,570

(22) Filed: Apr. 1, 2003

Related U.S. Application Data
(60) Provisional application No. 60/369,056, filed on Apr. 1, 2002.

(51) Int. Cl. G01B 3/22

(52) U.S. Cl. 33/832

(57) ABSTRACT

A tool for stripping a desired number of peels from a roll of paper includes a main body portion, a gauge and a stripping edge. The main body portion has a surface adapted to be gripped in the palm of a hand together with a generally planar face surface, a gauge projecting outwardly from the generally planar face of the main body portion by a distance selected to permit stripping the desired number of peels from the roll. The gauge is adapted to initiate a stripping operation by creating a gouge to the depth of the desired number of peels. The stripping edge is adapted for insertion into the gouge to the opposite edge of the roll in order to strip the desired number of peels. Also, a method of stripping a roll of paper of any damage and then stripping a desired number of peels from the roll includes the step of assessing the roll of paper for transit, plant or defective roll damage. Any damage to the roll is then stripped in incremental amounts until all such roll damage has been stripped. An axially extending gouge of a depth corresponding to a desired number of peels is formed of a selected length from a point inwardly of the edges of the roll to the nearest edge thereof. A stripping tool is placed under the gouge in the roll which is stripped axially to the edge opposite the gouge and after which the desired number of peels is removed from the roll, and then the roll is again assessed to ensure it is free of damage.

### CLAIM OF PRIORITY TO PROVISIONAL

This nonprovisional patent application of Robert Wenning claims the benefit of a prior-filed provisional patent application which was assigned provisional application No. 60/369,056 and a filing date of Mar. 1, 2002.

### FIELD OF THE INVENTION

The present invention is directed to a tool and method useful with rolls of paper for press operations and, more particularly, to a waste stripping tool and method for preparing rolls to press.

### BACKGROUND OF THE INVENTION

In the process of preparing rolls of paper for press operation, an excessive amount of waste is being created during the steps which are conventionally followed by the rolltender. This waste is the result of not having a gauge to identify a consistent number of peels, i.e., sheets of paper on the outer wrap of a roll to be removed. As a result, it has been recognized that having a tool capable of providing consistency in the stripping of waste for the rolltender's process of preparing rolls of paper for press operation would be desirable.

If this could be achieved, especially while reducing variation in the number of peels that are removed in the process, it would be possible to minimize the amount of waste, which would be a substantial benefit.

### SUMMARY OF THE INVENTION

In accordance with one aspect of the invention, a tool for stripping a desired number of peels from a roll of paper includes a main body portion, a gauge and a stripping edge. The main body portion has a surface which is adapted to be gripped in the palm of a hand together with a generally planar face surface from which the gauge projects. The gauge projects outwardly from the generally planar face of the main body portion by a distance selected to permit stripping the desired number of peels from the roll to avoid unnecessary waste. The gauge is adapted to initiate a stripping operation by creating a gouge to the depth of the desired number of peels from a point inwardly of an edge of the roll to the nearest edge. In addition, the stripping edge is adapted for insertion into the gouge and is used to extend the gouge to the opposite edge of the roll to strip the desired number of peels from the roll.

In accordance with another aspect of the invention, a method of stripping a roll of paper of any damage and then stripping a desired number of peels from the roll includes the step of assessing the roll of paper for transit, plant or defective roll damage. The method also includes the steps of stripping any damage to the roll in incremental amounts until all such roll damage has been stripped, forming an axially extending gouge of a depth corresponding to a desired number of peels in the roll where the gouge is of a selected length from a point inwardly of the edges of the roll to the nearest edge thereof, and placing a stripping tool under the gouge in the roll and stripping the roll axially to the edge opposite the gouge. Further, the method includes the steps of removing the desired number of peels from the roll after the roll has been stripped by extending the gouge to the edge opposite the gouge of selected length and then again assessing the roll to ensure it is free of damage.

Other object, advantages and features of the present invention will be appreciated from a consideration of the following specifications taken in conjunction with the accompanying drawings.

### BRIEF DESCRIPTION OF THE DRAWINGS

FIG. 1 is a front elevation of a waste stripping tool;

FIG. 2 is a top plan view of the tool of FIG. 1;

FIG. 3 is an end elevation of the tool of FIG. 1;

FIG. 4 is a cross-sectional view taken along the line 4-4 in FIG. 2;

FIG. 5 is a cross-sectional view taken along the line 5-5 in FIG. 1;

FIG. 6 is a cross-sectional view taken along the line 6-6 of FIG. 1;

FIG. 7 is a front elevation of the tool with a cone point screw;

FIG. 8 is a top plan view of the tool of FIG. 7; FIG. 9 is an end elevation of the tool of FIG. 7;

FIG. 10 is a side elevation of the cone point screw;

FIG. 11 is an end elevation of the cone point screw; and

FIG. 12 is a block diagram of a process for using the tool of FIGS. 1-11.

### DETAILED DESCRIPTION OF THE PREFERRED EMBODIMENTS

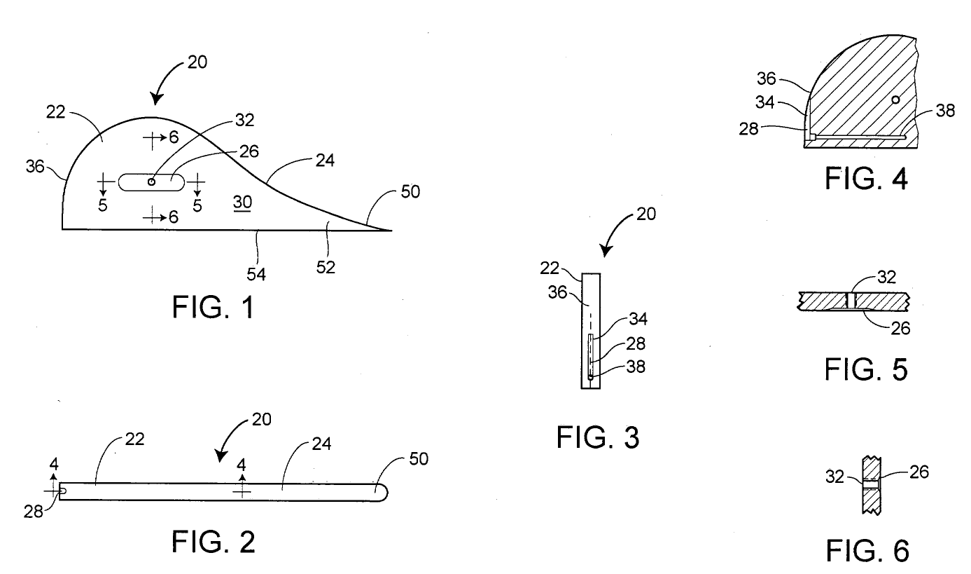

Referring to FIGS. 1-6, the reference numeral 20 designates generally a waste stripping tool in accordance with the present invention which includes a main body portion 22. The main body portion 22 comprises a stripper plate having a curved perimeter surface 24 that may be gripped in the palm of the hand. The exact shape of the curved perimeter surface 24 can be modified to fit a specific rolltender's hand. The manner of modifying the curved perimeter surface 24 will depend upon the material of the tool as will be apparent to those skilled in the art. As will be appreciated from FIGS. 1-3, the waste stripping tool 20 is a generally flat, elongated tool with region 26 for receiving a gauge and region 28 for receiving a hex Allen key.

Referring to FIGS. 5 and 6, region 26 comprises a slightly indented region in face 30 of the main body portion 22, wherein the face 30 is generally planar with the exception of the region 26. In other words, region 26 provides a slight recess in the face 30 of the main body portion 22 which surrounds a threaded opening 32 that extends entirely through the main body portion 22.

With regard to region 28 for the hex Allen key, it may suitably include a recess 34 in the front surface 36 of the body portion 22. The recess 34 extends downwardly to a point which has a bore 38 that extends inwardly generally parallel to the face 30 to receive the longer leg of a hex Allen key with the shorter leg being received in the recess 34. By referring to FIGS. 8 and 9, the manner in which the recess 34 receives the shorter leg 40 of a hex Allen key will be understood.

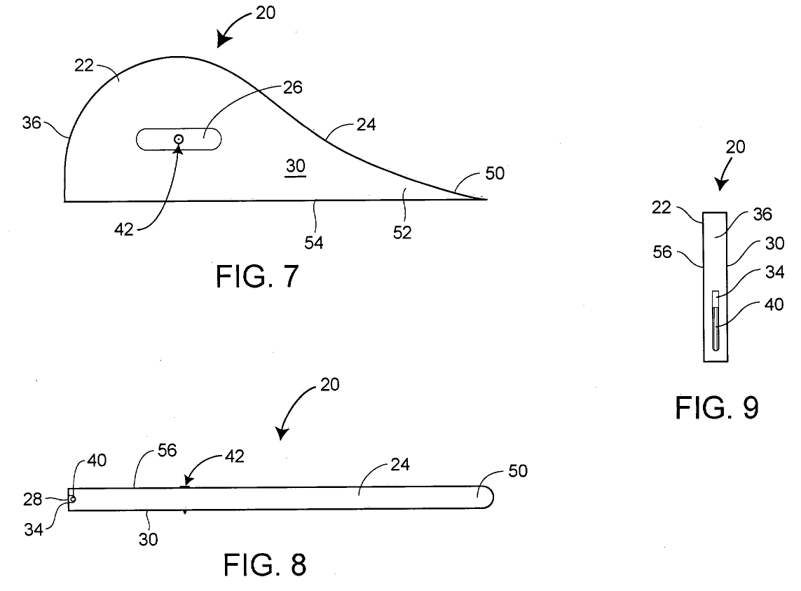

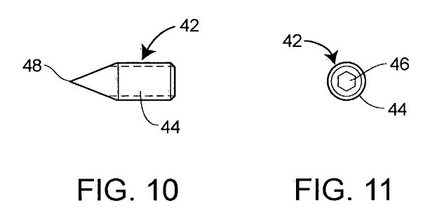

Referring now to FIGS. 7, 10 and 11, it will be seen and understood that the threaded bore 32 through the body portion 22 of the waste stripping tool 20 is adapted to receive a gauge which may take the form of a cone point hexagon set screw 42. The cone point hexagon set screw 42 will have threads on generally cylindrical surface 44, a hexagonal opening 46 in one end for threadably adjusting the cone point hexagon set screw 42 within the threaded bore 32, and a point 48 at the other end. In this manner, the point 48 can be adjustably positioned relative to the flat face 30 of the main body portion 22 to project outwardly by a distance selected to initiate stripping a desired number of peels to avoid unnecessary waste of paper.

The cone point hexagon set screw 42 is adapted to initiate a stripping operation by creating a gouge or slit in the roll of paper. The gouge or slit is of a depth selected to remove the desired number of peels and extends from a point inwardly of an edge of the roll to the nearest edge thereof. The main body portion 22 also has a stripping edge 50 for insertion into the gouge and is used to extend the gouge to the opposite edge of the roll. The stripping edge 50 is used to complete the stripping operation following use of the gauge to establish the depth of the gouge in order to strip the desired number of peels from the roll. Thus, the tool 20 includes two complementary working components, i.e., the gauge 42 and the stripping edge 50.

As shown in FIGS. 1 and 7, the curved surface 24 of the main body portion 22 extends from the front face 36 to a narrow rear region 52 and takes the form of a continuous, generally snail-shaped surface. The main body portion 22 also includes a straight surface 54 that extends from the front face 36 to the narrow rear region 52 at the far end of the tool 20. The narrow rear region 52 which is so defined by the curved surface 24 and the straight surface 54 remote from the front face 36 of the tool 20 comprising the stripping edge 50.

Referring to FIGS. 8 and 9, the tool 20 has a generally planar rear surface 56 closely spaced from and parallel to the planar face 30. The threaded bore 32 is formed in the main body portion 22 in a manner to receive the threaded set screw such as 42. The threaded bore 32 extends generally perpendicular to and extends entirely through the generally planar face 30 and rear surface 36.

More specifically, the cone point hexagon set screw 42 having the point 48 can be variably placed within the threaded bore 32 relative to the face 30 in the waste stripping tool 20 to provide adjustment for paper type, wear and personal preference while making it possible to closely control the specific number of peels from a given roll of paper that will be removed in a stripping operation.

With the waste stripping tool 20, it is possible to achieve a conservative reduction in peel waste of 50% which amounts to a reduction of six peels per roll of paper. It is not uncommon in a modern printing facility to run tens of thousands of rolls of paper each year which means, e.g., if a press room ran 65,000 rolls of paper, and the average reduction in waste amounted to six peels per roll, there would be a saving of 390,000 peels times an estimated weight of 0.75 pounds per peel which would equal 292,500 pounds of paper saved. With a typical salvage cost of $0.22 per pound for paper of the type used in a modern printing facility, this would produce an estimate cost savings on the order of nearly $65,000.

As will be appreciated, the foregoing economic analysis is merely illustrative of the types of savings that can be achieved based upon a conventional number of rolls of paper that might be run by a modern press room.

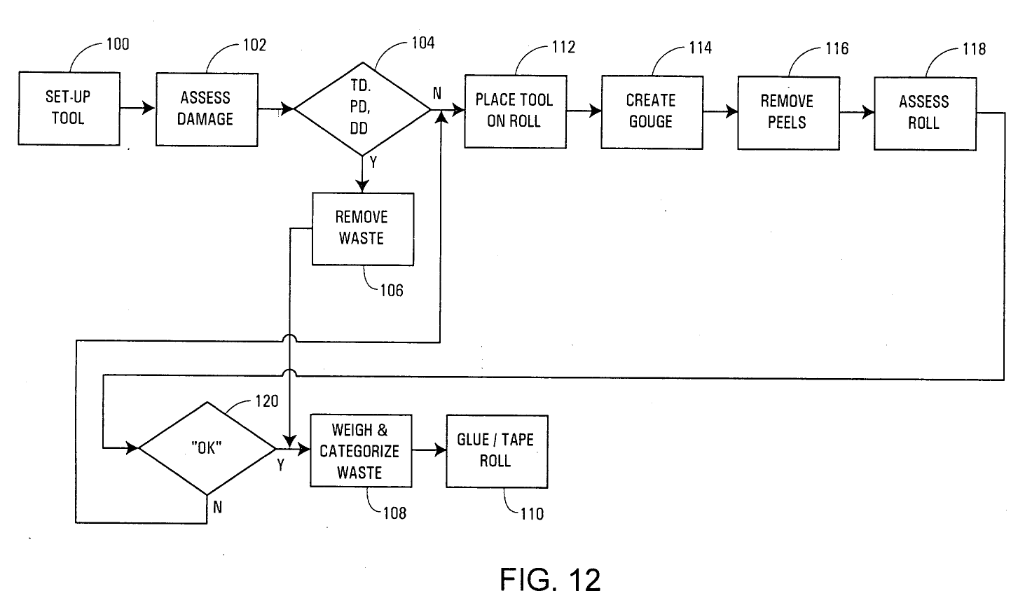

Referring now to FIG. 12, a waste stripping tool process is illustrated in the block diagram which includes setting up the tool as at block 100 by adjusting the gauge such as a cone point or needle. This will typically be done at the start of a plant shift to remove four to five peels of paper from a new roll following which an assessment of damage is made as at block 102. The assessment of damage will include looking for transit, plant, and defective roll damage or any other form of damage that may be detected. If any damage is present, the decision block 104 will tell the rolltender to remove waste as at block 106 by using the stripping edge of the waste stripping tool 20. The stripping edge of the tool will be used in an incremental manner which will be calculated to remove no more than approximately 26 pounds of paper at a time. The rolltender will weigh and categorize waste until of the waste has been removed from the roll of paper as at block 108 following which the rolltender will glue/tape the roll as at block 110. After waste removal, weighing categorizing, and gluing/taping, the rolltender will place the waste stripping tool 20 on the roll as at block 112 approximately two inches in from the edge of the roll. The tool 20 will be placed on the roll so that the gauge such as a cone point or needle can be used to create a gouge or slit as at block 114. In this connection, the gouge or slit will typically be formed by firmly placing a hand on the waste stripping tool 20 and pulling the tool past the nearest edge of the roll.

After the gouge or slit has been created at block 114, the rolltender will undertake to remove the requisite number of peels by using the stripping edge 50 of the waste stripping tool 20 (see FIGS. 1, 2, 7 and 8) as at block 116. The stripping edge 50 will then be placed under the gouged or slit peels created as at block 114 and the rolltender will proceed to strip the roll along its entire length, i.e., to the edge opposite where the gouge was created. At that point, the rolltender again assesses the roll as at 118 by looking for dimples from the point 48 of the cone point or needle and will otherwise ensure the roll is free of any concealed damage as at block 118.

If the assessment determines as at block 120 that the roll is not “OK”, i.e., free of concealed damage, the process is repeated beginning again as at block 112. Otherwise, the peels removed as at block 116 are weighed and categorized and the process is completed so that the roll of paper is ready for use in the printing facility.

While in the foregoing there have been set forth details of the preferred embodiments of the invention, it will be understood and appreciated that the invention is only to be limited by the true spirit and scope of the appended claims.

What is claimed is:

1. A tool for stripping a desired number of peels from a roll of paper, comprising:
a main body portion having a surface adapted to be gripped in the palm of a hand and having a generally planar face; and
a gauge projecting outwardly from the generally planar face of the main body portion by a distance selected to permit stripping a desired number of peels from the roll to avoid unnecessary waste, the gauge being adapted to initiate a stripping operation by creating a gouge to the depth of the desired number of peels from a point inwardly of an edge of the roll to the nearest edge thereof;
the main body portion also having a stripping edge for insertion into the gouge and under the desired number of peels to extend the gouge to the opposite edge of the roll in order to strip the desired number of peels from the roll.

2. The tool of claim 1 wherein the generally planar face of the main body portion has a slight recess formed therein, the recess in the generally planar face surrounding a threaded bore formed therein, the threaded bore surrounding the recess extending through the main body portion.

3. The tool of claim 1 wherein the gauge comprises a threaded set screw threadably received within a threaded bore, the set screw having a hexagonal opening in one end for adjustment within the threaded bore, the set screw having a point on the other end for creating the gouge in the roll of paper.

4. The tool of claim 1 wherein the main body portion has a curved surface extending from a front face to a narrow rear edge, the curved surface of the main body portion having a continuous, generally snail-shaped surface, the rear edge remote from the front face of the main body portion comprising the stripping edge.

5. The tool of claim 1 wherein the main body portion has a curved surface extending from a front face to a narrow rear region, and including a straight surface extending from the front face to the narrow rear region, the narrow rear region defined by the curved surface and straight surface comprising the stripping edge.

6. The tool of claim 1 including a generally planar rear surface closely spaced from and parallel to the generally planar face, a threaded bore formed in the main body portion to receive a threaded set screw, the threaded bore extending through the generally planar face and generally planar rear surface.

7. The tool of claim 1 wherein the main body portion includes a front face having a recess formed therein, the front face having a bore extending into the main body portion parallel to the generally planar face, and including a hex Allen key having a long leg disposed in the bore and a short leg disposed in the recess.

8. A tool for stripping a desired number of peels from a roll of paper, comprising:
a main body portion having a surface adapted to be gripped in the palm of a hand and having a generally planar face, a generally planar rear surface closely spaced from and parallel to the generally planar face, a curved perimeter surface portion extending from a front face to a narrow rear region, and a straight surface extending from the front face to the narrow rear region, the curved surface and straight surface at a point remote from the front face defining a stripping edge; and
a gauge projecting outwardly from the generally planar face of the main body portion by a distance selected to permit stripping a desired number of peels from the roll to avoid unnecessary waste, the gauge being adapted to initiate a stripping operation by creating a gouge to the depth of the desired number of peels from a point inwardly of an edge of the roll to the nearest edge thereof;
the stripping edge being adapted for insertion into the gouge and under the desired number of peels to extend the gouge to the opposite edge of the roll in order to strip the desired number of peels from the roll.

9. The tool of claim 8 wherein the generally planar face of the main body portion has a slight recess formed therein, the recess in the generally planar face surrounding a threaded bore formed therein, the threaded bore surrounded by the recess extending entirely through the main body portion.

10. The tool of claim 8 wherein the gauge comprises a threaded set screw threadably received within a threaded bore, the set screw having a hexagonal opening in one end for adjustment within the threaded bore, the set screw having a point on the other end for initiating stripping of the desired number of peels.

11. The tool of claim 8 wherein the main body portion has a curved surface extending from a front face to a narrow rear region, the curved surface having a continuous, generally snail-shaped surface, the rear region remote from the front face of the main body portion comprising the stripping edge.

12. The tool of claim 8 wherein the front face in the main body portion has a recess formed therein, the front face having a bore extending into the main body portion parallel to the generally planar face, and including a hex Allen key having a long leg disposed in the bore and a short leg disposed in the recess.

13. A method of stripping a roll of paper of any damage and then stripping a desired number of peels from the roll of paper, comprising the steps of:
assessing the roll of paper for transit, plant or defective roll damage for stripping away as waste;
stripping any damage to the roll in incremental amounts until all such roll damage has been stripped;
forming an axially extending gouge of a depth corresponding to a desired number of peels in the roll;
the gouge being of a selected length from a point inwardly of the edges of the roll to the nearest edge thereof;
placing a stripping tool under the gouge in the roll and stripping the roll axially to the edge opposite the gouge;
removing the desired number of peels from the roll after the roll has been stripped to the edge opposite the gouge; and
again assessing the roll to ensure it is free of damage.

14. The method of claim 13 wherein the stripping of damage to the roll in incremental amounts includes removing only a predetermined desired amount of the roll in a first stripping step, assessing the roll for further damage, and again removing only the predetermined desired amount of the roll in subsequent stripping steps until all roll damage has been removed from the roll.

15. The method of claim 14 including the further step of weighing and categorizing the amount removed from the roll in the first stripping step and weighing and categorizing the amount removed from the roll in subsequent stripping steps in incremental amounts of no more than approximately 26 pounds until all transit, plant or defective roll damage has been stripped from the roll.

16. The method of claim 13 wherein the point inwardly of the edges of the roll is approximately 2 inches inwardly of the nearest edge.
